(19) United States
(12) Patent Application Publication
(10) Pub. No.: US 2026/0235122 A1
(43) Pub. Date: Aug. 13, 2026

(54) SCROLL COMPRESSOR

(71) Applicant: Hanon Systems, Daejeon (KR)

(72) Inventors: Jong Hyun Jeon, Daejeon (KR); Kwang Jin Kim, Daejeon (KR); Kyung Jae Lee, Daejeon (KR)

(21) Appl. No.: 18/292,976

(22) PCT Filed: Mar. 20, 2023
(86) PCT No.: PCT/KR2023/003683

§ 371 Date: Jul. 24, 2025

(30) Foreign Application Priority Data
Apr. 19, 2022 (KR) 10-2022-0048484

(51) Int. Cl. F04C 18/02; F04C 27/00; F04C 29/12

(52) U.S. Cl. CPC F04C 18/0215; F04C 27/005; F04C 29/124; F04C 2240/30

(57) ABSTRACT

A scroll compressor, including: a housing; a motor provided inside the housing; a rotary shaft configured to be rotated by the motor; an orbiting scroll configured to orbit in conjunction with the rotary shaft; and a fixed scroll configured to define a compression chamber together with the orbiting scroll, and the housing may include a rear housing which defines a discharge chamber configured to accommodate a refrigerant discharged from the compression chamber; and an injection valve assembly configured to define an introduction chamber into which a refrigerant is introduced from an outside of the housing in the rear housing and guide a refrigerant of the introduction chamber to the compression chamber may be provided between the fixed scroll and a partition wall of the rear housing, and in the partition wall, a stepped portion on which a part of the injection assembly may be seated is provided.

### CROSS REFERENCE TO RELATED PATENT APPLICATIONS

This is a U.S. national phase patent application of PCT/KR2023/003683 filed Mar. 20, 2023 which claims the benefit of and priority to Korean Patent Application No. 10-2022-0048484, filed on Apr. 19, 2022, the entire contents of each of which are incorporated herein by reference.

### TECHNICAL FIELD

The present disclosure relates to a scroll compressor, more particularly, a scroll compressor capable of improving performance and efficiency of the compressor by introducing not only a suction-pressure refrigerant, but also a middle-pressure refrigerant into a compression chamber of the scroll compressor so as to increase a refrigerant discharge amount discharged from the compression chamber.

### BACKGROUND ART

In general, an air conditioning (A/C) device is installed in a vehicle to cool or heat the interior of the vehicle. The air conditioning device includes a compressor which is a component of a cooling system, and the compressor compresses a low-temperature and low-pressure gaseous refrigerant introduced from an evaporator to make a high-temperature and high-pressure gaseous refrigerant and delivers the refrigerant to a condenser.

The compressors are classified into a reciprocating compressor which compresses a refrigerant using a reciprocating motion of a piston, and a rotary compressor which compresses a refrigerant using a rotational motion. Depending on methods of transmitting driving power, the reciprocating compressors are classified into a crank compressor which transmits power to a plurality of pistons using a crank, and a swash plate compressor which transmits power to a shaft on which a swash plate is installed. The rotary compressors are classified into a vane rotary compressor which uses a rotating rotary shaft and vanes, and a scroll compressor which uses an orbiting scroll and a fixed scroll.

The scroll compressor has an advantage in that the scroll compressor may obtain a relatively higher compression ratio than other compressors, smoothly perform processes of introducing, compressing, and discharging the refrigerant, and thus obtain stable torque. Therefore, the scroll compressor is widely used to compress the refrigerant in an air conditioning device or the like.

FIG. 1 is a cross-sectional view illustrating a scroll compressor according to a prior art.

Referring to FIG. 1, the prior art scroll compressor includes a housing 100, a motor 200 provided in the housing 100, a rotary shaft 300 configured to be rotated by the motor 200, an orbiting scroll 400 configured to orbit in conjunction with the rotary shaft 300, and a fixed scroll 500 configured to define a compression chamber together with the orbiting scroll 400.

The prior art scroll compressor according to the above configuration goes through a series of process in which the rotary shaft 300 is rotated together with a rotor of the motor 200 when the power is applied to the motor 200, and the orbiting scroll 400 is orbited in conjunction with the rotary shaft 300, and a refrigerant is sucked into the compression chamber C by the orbital motion of the orbiting scroll 400 to be compressed and is discharged from the compression chamber C.

However, the prior art scroll compressor had a problem in that the refrigerant amount being discharged from the compression chamber C is determined, thereby limiting improvement of performance and efficiency of the compressor.

### SUMMARY

An object of the present disclosure is to provide a scroll compressor capable of improving performance and efficiency of the compressor by introducing a middle-pressure refrigerant as well as a suction pressure refrigerant into the compression chamber of the scroll compressor so as to increase a refrigerant amount discharged from the compression chamber.

Technical objects to be achieved by the present disclosure are not limited to the aforementioned objects, and those skilled in the art to which the present disclosure pertains may evidently understand other technical objects from the following description.

One embodiment is a scroll compressor, including: a housing; a motor provided inside the housing; a rotary shaft configured to be rotated by the motor; an orbiting scroll configured to orbit in conjunction with the rotary shaft; and a fixed scroll configured to define a compression chamber together with the orbiting scroll, and the housing may include a rear housing which defines a discharge chamber configured to accommodate a refrigerant discharged from the compression chamber; and an injection valve assembly configured to define an introduction chamber into which a refrigerant is introduced from an outside of the housing in the rear housing and guide a refrigerant of the introduction chamber to the compression chamber may be provided between the fixed scroll and a partition wall of the rear housing, and in the partition wall, a stepped portion on which a part of the injection assembly may be seated is provided.

According to the embodiment, the partition wall may protrude from a rear base plate of the rear housing so as to form a space of the introduction chamber therein, and the stepped portion may be formed along an inner periphery of the partition wall.

According to the embodiment, the injection valve assembly may include a gasket retainer configured to prevent a leak between the discharge chamber and the introduction chamber, and the gasket retainer may be coupled to the partition wall so as to surround the stepped portion.

According to the embodiment, a shape, and a size of a periphery of the gasket retainer may be identical to a shape and a size of an outer periphery of the partition wall.

According to the embodiment, the injection valve assembly may further include: a cover plate seated on the stepped portion and having an inlet into which the refrigerant from the introduction chamber is introduced; an injection valve interposed between the cover plate and the gasket retainer and configured to open or close the inlet; and a valve plate coupled to the gasket retainer and having an outlet through which the refrigerant introduced from the inlet is discharged.

According to the embodiment, a shape, and a size of an outer periphery of the stepped portion may be identical to a shape and a size of a periphery of the cover plate.

According to the embodiment, a height (h) of the stepped portion may be identical to a thickness (t) of the cover plate.

According to the embodiment, the gasket retainer may be compressed between the partition wall and the valve plate, and the injection valve may be compressed between the gasket retainer and the cover plate.

According to the embodiment, the gasket retainer may include a bead portion protruding from an upper surface of the gasket retainer opposite to the partition wall, and the bead portion may surround the injection valve.

According to the embodiment, when the gasket retainer is assembled between the partition wall and the valve plate, the bead portion may be pushed in a direction toward the valve plate by the partition wall, and an internal portion of the gasket retainer facing the injection valve may be bent in a direction toward the injection valve.

According to the embodiment, the gasket retainer may further include one or more retainer portions formed to be inclined in a direction in which the injection valve is opened.

According to the embodiment, a fastening bolt penetrates the valve plate and the gasket retainer to be fastened to the rear housing.

According to the embodiment, a positioning pin may have one end inserted into the valve plate to penetrate the gasket retainer, the injection valve, and the cover plate, and another end inserted into the rear housing.

According to the embodiment, the housing may further include a center housing allowing the rotary shaft to penetrate, and a front housing forming a motor accommodating space in which the motor is accommodated together with the center housing, and a sucked refrigerant may be introduced through the front housing into the compression chamber, and at least a part of a refrigerant discharged outside the housing may be introduced, in a state of middle-pressure, from an outside of the housing into the introduction chamber, and introduced into the compression chamber through the injection valve assembly.

According to the present disclosure, since a middle-pressure refrigerant as well as a suction pressure refrigerant is introduced into the compression chamber and the refrigerant amount discharged from the compression chamber can be increased, performance and efficiency of the compressor may be improved.

In addition, a part of the injection valve assembly, for example, a cover plate is seated on a stepped portion provided on a partition wall of a rear housing, and the cover plate by itself may serve as a sealing that can prevent internal leakage between the compression chamber and the introduction chamber. Therefore, an additional O-ring between the cover plate and the partition wall of the rear housing and a processing to form a groove for the O-ring is not necessary, therefore, the number of parts, and time and an expense for the processing can be reduced, and a problem of the O-ring leaving the groove does not occur.

Further, since the injection valve assembly includes a gasket retainer coupled to the partition wall such that the gasket retainer surrounds the stepped portion, an internal leakage between the discharge chamber and the introduction chamber may be prevented by means of a single sealing member (gasket retainer).

It should be appreciated that the advantageous effects of the present disclosure are not limited to the effects described above, but encompass all effects that can be derived from the configurations of the present invention disclosed in the detailed description of the invention or the appended claims.

### DESCRIPTION OF DRAWINGS

FIG. 1 is a cross-sectional view that illustrates a conventional scroll compressor,

FIG. 2 is a cross-sectional view that illustrates a scroll compressor according to an embodiment of the present disclosure,

FIG. 3 is a cross-sectional view that illustrates a rear housing in a scroll compressor of FIG. 2 viewed in a different direction,

FIG. 4 is a partially cross-sectional perspective view that illustrates a rear housing in a scroll compressor of FIG. 2 in a state in which the rear housing is separated from the scroll compressor of FIG. 2,

FIG. 5 is an exploded perspective view that illustrates the rear housing of the scroll compressor of FIG. 2 and parts accommodated in the rear housing,

FIG. 6 is a front view that illustrates a fixed scroll and a discharge valve among the parts of FIG. 5,

FIG. 7 is an exploded perspective view that illustrates an injection valve assembly among the parts of FIG. 5,

FIG. 8 is a cross-sectional view that illustrates a state in which the injection valve assembly of FIG. 7 is stacked before fastening,

FIG. 9 is a rear view of a cover plate in the injection valve assembly of FIG. 7,

FIG. 10 is an exploded perspective view that illustrates the rear housing and a cover plate among the parts of FIG. 5 viewed in a different direction,

FIG. 11 is a rear view of a gasket retainer in the injection valve assembly of FIG. 7,

FIG. 12 is a rear view of a valve plate in the injection valve assembly of FIG. 7,

FIG. 13 is a perspective view of a part taken along line I-I of FIG. 6,

FIG. 14 is a rear view of a fixed scroll in the scroll compressor of FIG. 2,

FIGS. 15 to 18 are cross-sectional views that illustrate a fixed wrap, an orbiting wrap, a discharge hole, and an injection hole when a rotational angle of a rotary shaft is a first, a second, a third, and a fourth angle, respectively,

FIG. 19 is a diagram showing the opening and closing timing of an injection hole.

### DESCRIPTION OF AN EMBODIMENT

Hereinafter, exemplary embodiments of a scroll compressor according to the present disclosure will be described in detail with reference to the accompanying drawings.

In addition, the terms used below are defined considering the functions in the present disclosure and may vary depending on the intention of a user or an operator or a usual practice. The following embodiments are not intended to limit the protection scope of the present disclosure but just exemplary constituent elements disclosed claims in the present disclosure.

A part irrelevant to the description will be omitted to clearly describe the present disclosure, and the same or similar constituent elements will be designated by the same reference numerals throughout the specification. Throughout the specification, unless explicitly described to the contrary, the word “comprise/include” and variations such as “comprises/includes” or “comprising/including” will be understood to imply the inclusion of stated elements, not the exclusion of any other elements.

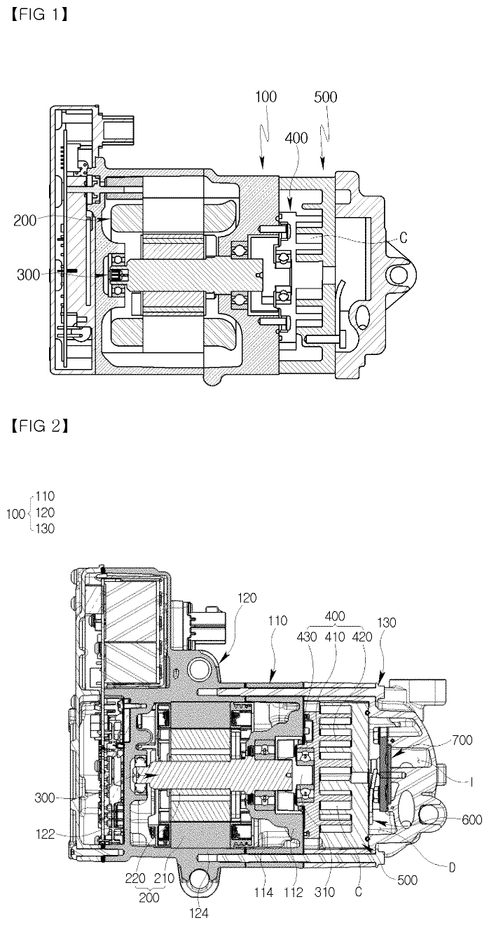

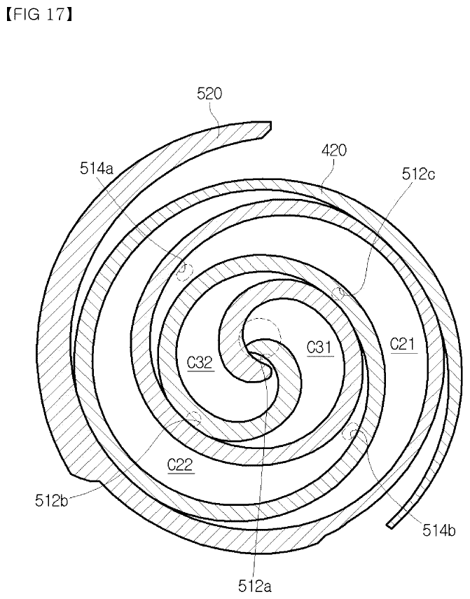

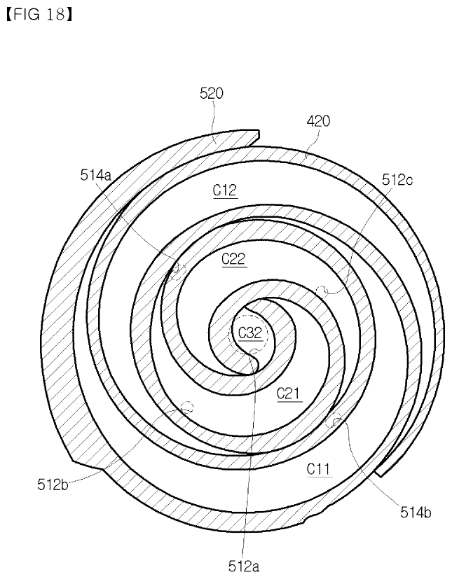

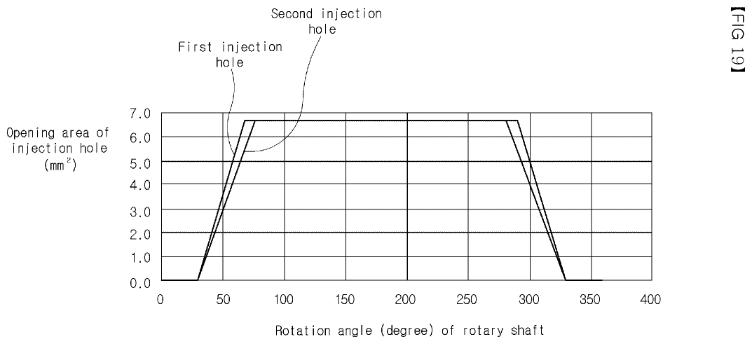

First, with reference to FIGS. 2 to 4, and 14 to 19, the scroll compressor according to the embodiment of the present disclosure will be described.

As illustrated in FIG. 2, the scroll compressor according to the embodiment of the present disclosure may include a housing 100, a motor 200 provided in the housing 100, a rotary shaft 300 configured to be rotated by the motor 200, an orbiting scroll 400 configured to orbit in conjunction with the rotary shaft 300, a fixed scroll 500 configured to define compression chambers C together with the orbiting scroll 400, and a discharge valve 600 disposed on one surface of the fixed scroll 500 and configured to open or close a discharge opening 512 of the fixed scroll from which a refrigerant compressed in the compression chamber C is discharged.

In addition, the compressor according to the present embodiment may further include an injection valve assembly 700 that defines and opens or closes an injection flow path configured to guide a middle-pressure refrigerant to the compression chamber C from the outside of the housing 100 (e.g., from a downstream side of a condenser in a vapor compression refrigeration cycle including a scroll compressor, the condenser, an expansion valve, and an evaporator).

Here, the injection flow path includes an introduction port 133, the introduction chamber I, an inlet 712, an inclined space 734, an outlet 736, and an injection hole 514, and extends from the rear housing 130 to the fixed scroll 500, and the injection valve assembly 700 includes the inlet 712, the inclined space 734, and the outlet 736, and is interposed between the rear housing 130 and the fixed scroll 500.

In more detail, the housing 100 may include a center housing 110 through which the rotary shaft 300 passes, a front housing 120 forming a motor accommodating space in which the motor 200 is accommodated together with the center housing 110, and a rear housing 130 forming a scroll accommodating space in which the orbiting scroll 400 and the fixed scroll 500 are accommodated together with the center housing 110.

The center housing 110 may include a center base plate 112 partitioning the motor accommodating space and the scroll accommodating space and supporting the orbiting scroll 400 and the fixed scroll 500, and a center side plate 114 protruding from an outer periphery of the center base plate 112 to the front housing 120. A shaft hole through which one end of the rotary shaft 300 passes and a back pressure chamber for pressing the orbiting scroll 400 toward the fixed scroll 500 may be formed in the center of the center base plate 112. Here, an eccentric bush 310 for converting the rotational motion of the rotary shaft 300 into the orbital motion of the orbiting scroll 400 is formed at one end of the rotary shaft 300. In addition, a suction flow path (not illustrated) guiding the refrigerant flowing into the motor accommodating space to the scroll accommodating space, as will be described later, may be formed on the outer periphery of the center base plate 112.

The front housing 120 may include a front base plate 122 opposite to the center base plate 112 and supporting the other end of the rotary shaft 300, and a front side plate 124 protruding from an outer periphery of the front base plate 122, coupled to the center side plate 114, and supporting the motor 200. Here, the center base plate 112, the center side plate 114, the front base plate 122, and the front side plate 124 may form the motor accommodating space. In addition, a suction port guiding a refrigerant having a suction pressure from an outside to the motor accommodating space may be formed on the front side plate 124.

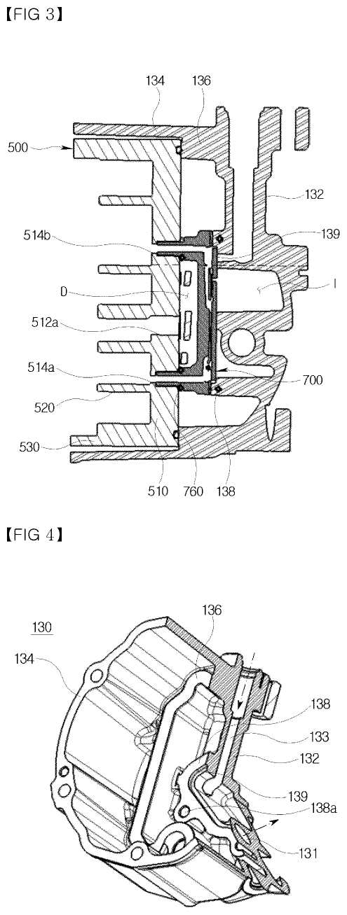

As shown in FIGS. 3 and 4, the rear housing 130 may include a rear base plate 132 opposite to the center base plate 112, a first annular wall 134 protruding from the rear base plate 132 and located at the outermost side in the circumferential direction of the rear housing 130, a second annular wall 136 protruding from the rear base plate 132 and accommodated in the first annular wall 134, and a partition wall 138 protruding from the rear base plate 132 and accommodated in the second annular wall 136. In this case, the first annular wall 134, the second annular wall 136, and the partition wall 138 are formed to have different heights from one another.

The first annular wall 134 may be formed in an annular shape having a diameter approximately equal to a diameter of the outer periphery of the center base plate 112, may be coupled to the outer periphery of the center base plate 112, and may form the scroll accommodating space. In addition, the second annular wall 136 may be formed in an annular shape having a smaller diameter than a diameter of the first annular wall 134, and may be in contact with an outer periphery of a fixed base plate 510 of the fixed scroll 500 to be described later, and may form the discharge chamber D accommodating a refrigerant discharged from the compression chamber C. Here, as the second annular wall 136 is formed to be in contact with the fixed base plate 510, when the rear housing 130 is coupled to the center housing 110, the fastening force between the center housing 110 and the fixed scroll 500 may be improved by pressing the fixed scroll 500 toward the center housing 110, thereby a leakage between the fixed scroll 500 and the center housing 110 may be prevented.

The partition wall 138 may be formed in an annular shape having a smaller diameter than a diameter of the second annular wall 136, may be spaced apart from the fixed base plate 510 of the fixed scroll 500, and may be covered by a cover plate 710 of the injection valve assembly 700 as will be described later, to form the introduction chamber I accommodating a refrigerant introduced through the introduction port 133.

The discharge port 131 is formed in the rear base plate 132 to guide the refrigerant in the discharge chamber D to the outside of the housing 100, and the discharge port 131 may be formed to extend from a center of the rear base plate 132 to one side of an outer periphery of the rear base plate 132 in a radial direction of the rear base plate 13. Meanwhile, a tubular oil separator (not illustrated) separating oil from a refrigerant may be provided inside the discharge port 131. In addition, the introduction port 133 through which medium-pressure refrigerant is introduced from the outside of the housing 100 is also formed in the rear base plate 132, the introduction port 133 may be formed extending from the other side of the outer periphery of the rear base plate 132 to the center of the rear base plate 132 in the radial direction of the rear base plate 132, and may be communicated with the introduction chamber I. Meanwhile, the discharge port 131 and the introduction port 133 may be formed so that the refrigerant of the discharge port 131 and the refrigerant of the introduction port 133 flow in a cross-flow direction with each other.

As such, when the discharge chamber D, the discharge port 131, the introduction port 133, and the introduction chamber I are formed in the rear housing 130, at least a part of the introduction chamber I is accommodated in the discharge chamber D, at least a part of the discharge port 131 is accommodated in the introduction chamber I, and at least a part of the introduction port 133 is accommodated in the discharge chamber D.

In addition, in the partition wall 138, as will be described later, a fastening groove 138a into which a fastening bolt 770 fastening a gasket retainer 790 and a valve plate 730 of the injection valve assembly 700 to the partition wall 138 is inserted, and a first positioning groove 138b into which a positioning pin 780 aligning the cover plate 710, an injection valve 720, the gasket retainer 790, and the valve plate 730 of the injection valve assembly 700 is inserted are formed.

As shown in FIG. 2, the motor 200 may include a stator 210 fixed to the front side plate 124 and a rotor 220 rotated by interaction with the stator 210 inside the stator 210. The rotary shaft 300 passes through a center of the rotor 220 and is coupled to the rotor 220, and one end of the rotary shaft 300 passes through the shaft hole of the center base plate 112, and the other end of the rotary shaft 300 may be supported on the front base plate 122.

The orbiting scroll 400 may be interposed between the center base plate 112 and the fixed scroll 500, and may include a disk-shaped orbiting base plate 410, an orbiting wrap 420 protruding from the orbiting base plate 410 to the fixed scroll 500, and a boss portion 430 protruding from the center of the orbiting base plate 410 to the opposite side of the orbiting wrap 420 and coupled to the eccentric bush 310.

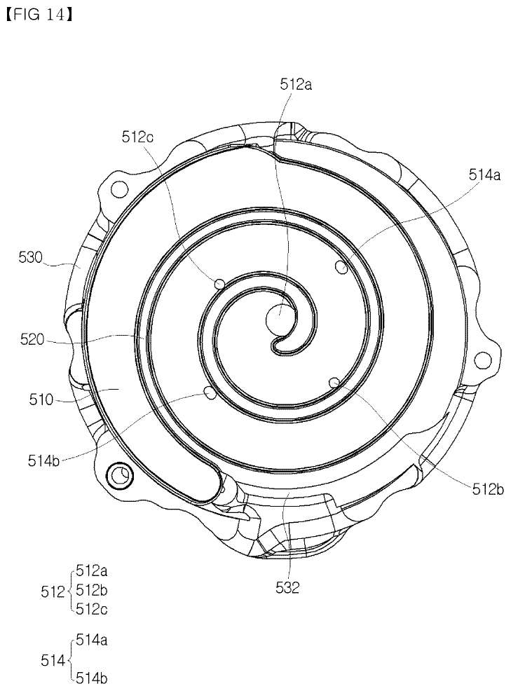

As shown in FIGS. 3 and 14, the fixed scroll 500 may include a disk-shaped fixed base plate 510, a fixed wrap 520 protruding from the fixed base plate 510 and engaged with the orbiting wrap 420, and a fixed side plate 530 protruding from an outer periphery of the fixed base plate 510 and coupled to the center base plate 112.

The fixed base plate 510 may include a discharge hole 512 discharging the refrigerant of the compression chamber C to the discharge chamber D, and an injection hole 514 guiding the refrigerant discharged from the injection valve assembly 700 to the compression chamber C. The discharge hole 512 may be formed in plurality to prevent the refrigerant from being over-compressed, and the plurality of discharge holes 512 may be opened and closed by a discharge valve 600 interposed between the fixed base plate 510 and the injection valve assembly 700.

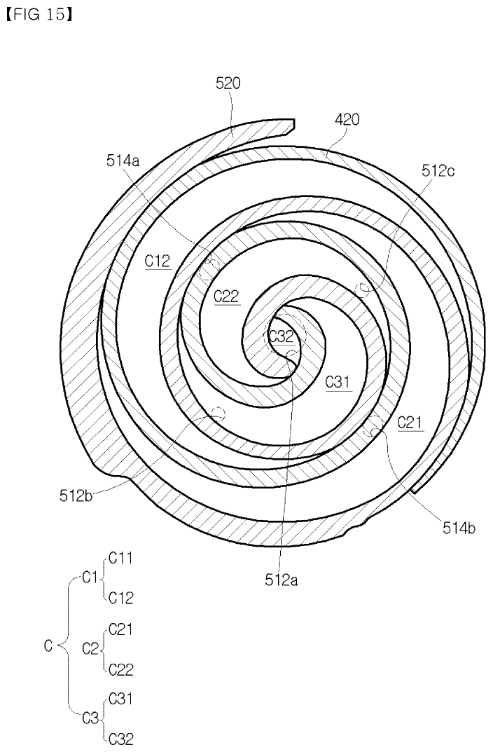

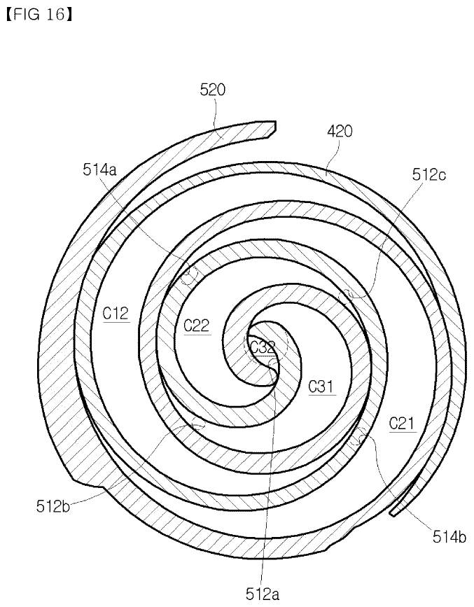

Specifically, as illustrated in FIGS. 15 to 18, the compression chamber C includes a first compression chamber C1 positioned on the distal side in the radial direction of the scroll accommodating space and having a pressure of a refrigerant fallen under a first pressure range, a second compression chamber C2 located on the centripetal side in the radial direction of the scroll accommodating space with respect to the first compression chamber C1 and having a pressure of a refrigerant fallen under a second pressure range higher than the first pressure range, and a third compression chamber C3 located on the centripetal side in the radial direction of the scroll accommodating space with respect to the second compression chamber C2 and having a pressure of a refrigerant fallen under a third pressure range higher than the second pressure range.

In more detail, the first compression chamber C1 may include a first outer compression chamber C11 formed by an outer peripheral surface of the orbiting wrap 420 and an inner peripheral surface of the fixed wrap 520, and a first inner compression chamber C12 formed by an inner peripheral surface of the orbiting wrap 420 and an outer peripheral surface of the fixed wrap 520. The second compression chamber C2 may include a second outer compression chamber C21 formed by the outer peripheral surface of the orbiting wrap 420 and the inner peripheral surface of the fixed wrap 520, and a second inner compression chamber C22 formed by the inner peripheral surface of the orbiting wrap 420 and the outer peripheral surface of the fixed wrap 520.

In this case, the discharge hole 512 may include a main discharge hole 512a formed in the center of the fixed base plate 510 to discharge the refrigerant of the third compression chamber C3, a first sub discharge hole 512b formed outside the fixed base plate 510 in a radial direction with respect to the main discharge hole 512a to discharge the refrigerant of the second outer compression chamber C21, and a second sub discharge hole 512c formed outside the fixed base plate 510 in a radial direction with respect to the main discharge hole 512a but formed on the opposite side of the first sub discharge hole 512b with respect to the main discharge hole 512a to discharge the refrigerant of the second inner compression chamber C22.

In addition, the injection hole 514 may be formed in plurality to fully supply the refrigerant discharged from the injection valve assembly 700 to the pair of first compression chamber C1. That is, the injection hole 514 may include a first injection hole 514a communicatable with the first outer compression chamber C11 and a second injection hole 514b communicatable with the first inner compression chamber C12, wherein the first injection hole 514a and the second injection hole 514b may be formed on opposite sides of each other with respect to an imaginary line connecting the first sub discharge hole 512b and the second sub discharge hole 512c. However, the injection hole 514 is not limited thereto, and the injection hole 514 may be formed in plurality on the same side with each other with respect to the imaginary line connecting the first sub discharge hole 512b and the second sub discharge hole 512c.

The injection hole 514 may be formed as a long hole to increase the flow rate of the refrigerant injected into the compression chamber C. In addition, the injection hole 514 may have a uniform cross-sectional shape so that pressure loss and flow rate loss do not occur while the refrigerant passes through the injection hole 514. That is, an inner diameter of the injection hole 514 may be formed to a predetermined value irrespective of the axial position of the injection hole 514.

Meanwhile, in order not to cause a pressure imbalance between the first outer compression chamber C11 and the first inner compression chamber C12, the injection hole 514 may be formed to communicate with the first outer compression chamber C11 and the first inner compression chamber C12 at the same time. That is, as shown in FIG. 19, when communication between the first injection hole 514a and the first outer compression chamber C11 is started, the communication between the second injection hole 514b and the first inner compression chamber C12 may be started. Also, preferably, the injection hole 514 may be formed to be simultaneously blocked from the first outer compression chamber C11 and the first inner compression chamber C12. That is, as shown in FIG. 19, when the communication between the first injection hole 514a and the first outer compression chamber C11 is terminated, the communication between the second injection hole 514b and the first inner compression chamber C12 may be terminated.

The fixed wrap 520 may be formed to extend, for example, in a logarithmic spiral from the central side of the fixed scroll 500 to the outer peripheral side of the fixed scroll 500. The fixed side plate 530 may be formed in an annular shape extending along the outer periphery of the fixed base plate 510, and may include a fixed wrap entry 532 connected to the fixed wrap 520 on one side. An axial height of the fixed wrap entry 532 may be formed at the same level as an axial height of the fixed wrap 520 so that the refrigerant of the compression chamber C does not leak through the fixed wrap entry 532. In addition, a radial thickness of the fixed wrap entry 532 may be formed to be thicker than a radial thickness of the fixed wrap 520 so that the support rigidity of the fixed wrap 520 is improved. Here, in order to reduce the weight and cost of the fixed scroll 500, the fixed side plate 530 may be formed so that a radial thickness of portion except for the fixed wrap entry 532 is thinner than a radial thickness of the fixed wrap entry 532.

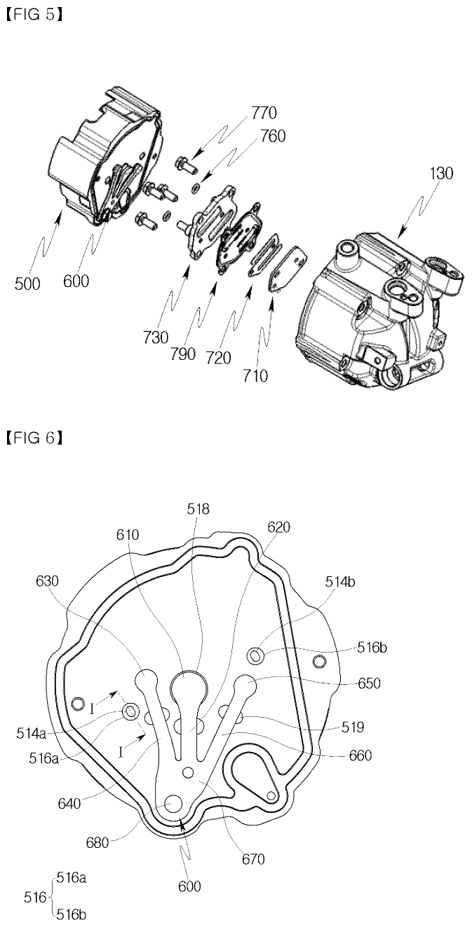

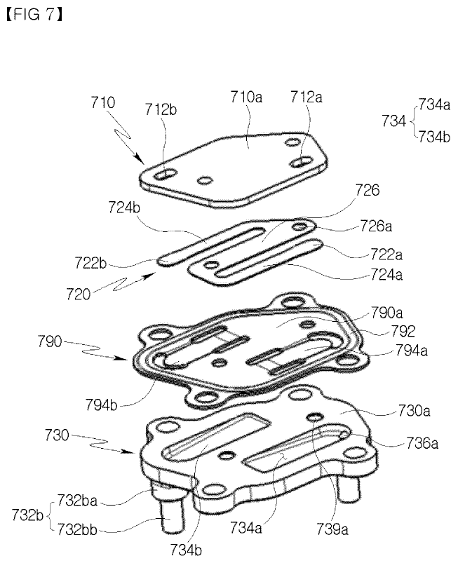

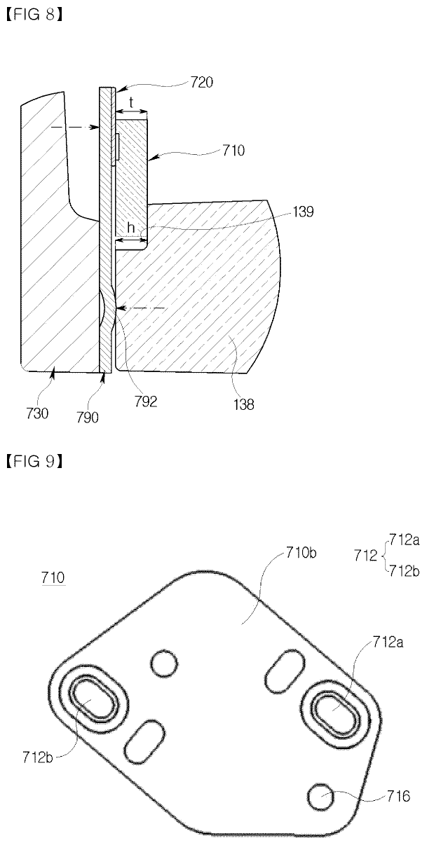

Next, referring to FIGS. 5 and 6, the discharge valve 600 will be described. The discharge valve 600 is interposed between the fixed base plate 510 and the injection valve assembly 700, and is configured to communicate and block between the discharge hole 512 and the discharge chamber D.

The discharge valve 600 may include a main opening/closing portion 610 opening and closing the main discharge hole 512a, a first sub opening/closing portion 630 opening and closing the first sub discharge hole 512b, a second sub opening/closing portion 650 opening and closing the second sub discharge hole 512c, a fastening portion 670 fastened to the fixed base plate 510, a main supporting portion 620 extending from the main opening/closing portion 610 to the fastening portion 670, a first sub supporting portion 640 extending from the first sub opening/closing portion 630 to the fastening portion 670, and a second sub supporting portion 660 extending from the second sub opening/closing portion 650 to the fastening portion 670.

In order to minimize the increase in cost and weight caused by the discharge valve 600, the main opening/closing portion 610, the first sub opening/closing portion 630, the second sub opening/closing portion 650, and the fastening portion 670, the main supporting portion 620, the first sub supporting portion 640 and the second sub supporting portion 660 may be integrally formed. In addition, a circumferential width of the fastening portion 670 may be formed smaller than a distance between the first sub opening/closing portion 630 and the second sub opening/closing portion 650, and the fastening portion 670 may be fastened to the fixed base plate 510 by one fastening member 680. Here, the one fastening member 680 may be preferably fastened to the fixed wrap entry 532 having a relatively great thickness and height, so that the discharge valve 600 may receive sufficient support even if the discharge valve 600 is fastened to the fixed base plate 510 by the one fastening member 680.

In some embodiment, at least one of the first sub supporting portion 640 and the second sub supporting portion 660 may interfere with the injection hole 514, in order to prevent this, at least one of the first sub supporting portion 640 and the second sub supporting portion 660 may include an avoidance portion 690 formed to be engraved toward the main supporting portion 620.

Here, the main opening/closing portion 610 opens the main discharge hole 512a when the pressure of the third compression chamber C3 reaches the discharge pressure level. In this case, the first sub opening/closing portion 630 opens the first sub discharge hole 512b when the pressure of the second outer compression chamber C21 exceeds the second pressure range so that the pressure of the second outer compression chamber C21 is lowered to the second pressure range, and the second sub opening/closing portion 650 opens the second sub discharge hole 512c when the pressure of the second inner compression chamber C22 exceeds the second pressure range so that the pressure of the second inner compression chamber C22 is lowered to the second pressure range, thereby preventing the pressure of the refrigerant discharged from the main discharge hole 512a from being excessively higher than the discharge pressure. That is, over-compression may be prevented.

Meanwhile, in order not to cause a pressure imbalance between the second outer compression chamber C21 and the second inner compression chamber C22, the first sub discharge hole 512b and the second sub discharge hole 512c may be formed to communicate with the second outer compression chamber C21 and the second inner compression chamber C22 at the same time. That is, when communication between the first sub discharge hole 512b and the second outer compression chamber C21 is started, the communication between the second sub discharge hole 512c and the second inner compression chamber C22 may be started. Also, preferably, the first sub discharge hole 512b and the second sub discharge hole 512c may be formed to be simultaneously blocked from the second outer compression chamber C21 and the second inner compression chamber C22. That is, when the communication between the first sub discharge hole 512b and the second outer compression chamber C21 is terminated, the communication between the second sub discharge hole 512c and the second inner compression chamber C22 may be terminated.

Next, referring to FIGS. 3, 5, and 7 to 12, the injection valve assembly 700 will be described in more detail. The injection valve assembly 700 may be formed on the end surface of the partition wall 138 to communicate and block between the introduction chamber I and the injection hole 514.

Particularly, in the present disclosure, a part of the injection valve assembly 700 is seated on the stepped portion 139 provided on the partition wall 138 of the rear housing. Accordingly, the injection valve assembly 700 itself may serve as a seal for preventing an internal leakage between the discharge chamber D and the introduction chamber I. Because of this, an additional O-ring between the injection valve assembly 700 and the partition wall 138 of the rear housing and a processing to form a groove for the O-ring is not necessary, therefore, the number of parts, and time and an expense for the processing can be reduced, and a problem of the O-ring leaving the groove does not occur.

Further, as will be described later, the injection valve assembly 700 includes the gasket retainer which serves as a leakage prevention means, together with the injection valve 720 opening or closing the injection flow path. The gasket retainer 790 is coupled to the partition wall 138 such that the gasket retainer surrounds the stepped portion 139, and accordingly, a single sealing member (gasket retainer) may prevent an internal leakage between the discharge chamber D and the introduction chamber I.

In more detail, the injection valve assembly 700 includes the cover plate 710 seated on the stepped portion 139 provided in the partition wall 138 and covering the introduction chamber I, the gasket retainer 790 coupled to the partition wall 138 so as to surround the stepped portion 139, the injection valve 720 interposed between the cover plate 710 and the gasket retainer 790 and opening or closing the injection flow path, and the valve plate 730 coupled to the gasket retainer 790 and guiding the middle-pressure refrigerant to the injection hole 514.

First, as shown in FIGS. 7 and 9, the cover plate 710 includes a cover plate upper surface 710a opposite to the partition wall 138 and a cover plate lower surface 710b opposite to the gasket retainer 790. In addition, the cover plate 710 further includes the inlet 712 communicating the introduction chamber I and the inclined space 734 to be described later with each other, and a first positioning hole 716 communicating with the first positioning groove 138b and penetrated by the positioning pin 780.

The injection hole 712 is formed to penetrate the cover plate 710 from the cover plate upper surface 710a to the cover plate lower surface 710b, and in the present embodiment, two inlets 712 are formed in a diagonal direction of the cover plate 710. That is, the inlet 712 may include a first inlet 712a that communicates with one side of the introduction chamber I, and a second inlet 712b formed independently of the first inlet 712a and communicating with the other side of the introduction chamber I. Here, it is preferable that the first inlet 712a and the second inlet 712b be formed into long holes for maximizing a valve lifting force and a refrigerant inlet flow rate, respectively.

The first positioning hole 716 may be formed in a diagonal direction of the cover plate 710, and preferably, in a diagonal direction intersecting a diagonal line at which the inlet 712 is formed, and may be formed to penetrate the cover plate 710 from the cover plate upper surface 710a to the cover plate lower surface 710b.

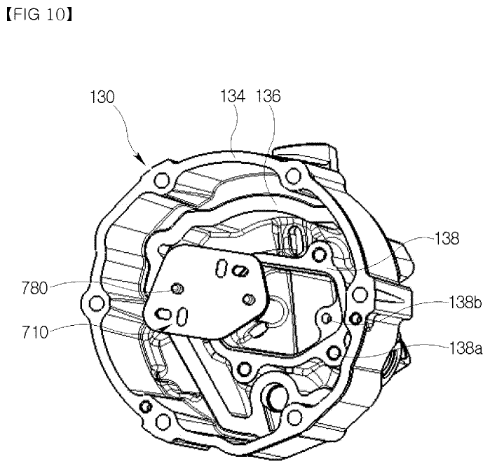

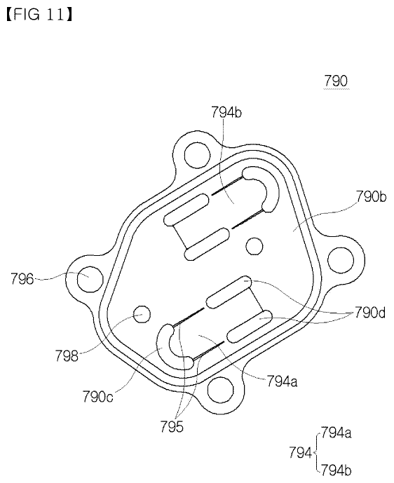

As shown in FIGS. 8 and 10, the stepped portion 139 is formed along an inner periphery of the partition wall 138. Accordingly, the cover plate 710 may be seated on the stepped portion 139 to cover the introduction chamber I on the inside of the partition wall 138. Here, a height (h) of the stepped portion 139 is preferably the same as a thickness (t) of the cover plate 710 so that the cover plate 710 can be seated on the inside of the partition wall 138, without protruding more than the partition wall 138. However, a slight error is permissible.

In addition, it is preferable that a shape and a size of an outer periphery of the stepped portion 139 be the same as a shape and a size of a periphery of the cover plate 710 so that the cover plate 710 can completely cover the introduction chamber I. However, a slight error is permissible.

As shown in FIG. 7, the injection valve 720 may include a first head 722a opening and closing the first inlet 712a, a first leg 724a supporting the first head 722a, a second head 722b opening and closing the second inlet 712b, a second leg 724b supporting the second head 722b, and a connecting portion 726 connecting the first leg 724a and the second leg 724b. In order to reduce the number of parts, a size, the cost, and weight, it is preferable that the first head 722a, the first leg 724a, the second head 722b, the second leg 724b, and the connecting portion 726 be integrally formed.

It is preferable on the perspective of being compactable that the first leg 724a and the second leg 724b be formed to be parallel to each other, and each of a linkage between the first leg 724a and the connecting portion 726 and a linkage between the second leg 724b and the connecting portion 726 be formed on an opposite side to each other. That is, the first leg 724a and the second leg 724b are connected, respectively, to both ends of the connecting portion 726.

In addition, the connecting portion 726 includes a second positioning hole 726a communicated with the first positioning hole 716 and penetrated by the positioning pin 780. In the present embodiment, the second positioning holes 726a are formed at both ends of the connecting portion 726, respectively, however, the present embodiment is not limited thereto.

Here, the injection valve 720 is compressed between the cover plate 710 and the gasket retainer 790 to be fixed therebetween, without requiring an additional fastening member for fixing the injection valve 720, and this will be described later in more detail.

As shown in FIGS. 7 and 11, the gasket retainer 790 includes a gasket retainer upper surface 790a opposite to the partition wall 138 and the cover plate 710, and a gasket retainer lower surface 790b opposite to the fixed scroll 500 while forming a rear surface of the gasket retainer upper surface 790a. In addition, the gasket retainer 790 further includes a bead portion 792 protruding along a periphery of the gasket retainer upper surface 790a, and a retainer portion 794 serving as a retainer of the injection valve 720 and formed to be inclined on the gasket retainer 790. Here, the retainer portion 794 is formed to be inclined in a direction in which the injection valve 720 is opened, that is a direction toward the valve plate 730. The retainer portion 794 is formed on an inner side of the bead portion 792.

The retainer portion 794 is configured to support the head 722 and the leg 724 of the injection valve 720, when the injection valve 720 opens the inlet 712, that is, when the head 722 and the leg 724 of the injection valve 720 are opened while being moved toward the valve plate 730. Depending on a determined inclination of the retainer portion 794, it is possible to limit a position at which the injection valve 720 is opened to the fullest. To this end, the retainer portion 794 includes a first retainer portion 794a for supporting the first head 722a and the first leg 724a, and a second retainer portion 794b for supporting the second head 722b and the second leg 724b.

Here, it is preferable that the first retainer portion 794a and the second retainer portion 794b be inclined in directions mutually opposite to each other so as to correspond to the first leg 724a and the second leg 724b. That is, the first retainer portion 794a and the second retainer portion 794b are formed to be inclined on the gasket retainer 790 by cut portions, with the cut portions formed in directions mutually opposite to each other. In more detail, the cut portions in the present embodiment are formed in a U-shape, and inner portions cut by the cut portions on a body of the gasket retainer 790, which are the retainer portions, are formed to be inclined.

Here, in order to maintain an inclination angle of the retainer portion, a pair of wing portions 795 connecting both sides of the retainer portion 794 to the body of the gasket retainer facing the both sides are provided at both sides of the retainer portion 794. Therefore, a U-shaped main flow hole 790c may be formed on one side of the pair of the wing portions 795, and a pair of straight auxiliary flow holes 790d may be formed on the other side thereof. When the injection valve 720 is opened, the refrigerant being introduced into the inlet 712 of the cover plate may flow to the inclined space 734 of the valve plate through the main flow hole 790c and the pair of auxiliary flow holes 790d. As such, as the pair of wing portions 795 are provided, it is possible to maintain the inclination angle of the retainer portion 794 uniformly, and at the same time, to maintain the durability even if the retainer portion 794 is continuously hit by the injection valve 720.

As shown in FIGS. 3 to 8, the gasket retainer 790 is compressed between the partition wall 138 and the valve plate 730. Therefore, the injection valve 720 may be compressed between the cover plate 710 and the gasket retainer 790 so as to be fixedly positioned therebetween, and at the same time, the gasket retainer 790 may seal between the partition wall 138 and the valve plate 730. As such, since the gasket retainer 790 is compression-bonded to the partition wall 138 to surround the stepped portion 139, it is possible to prevent an internal leakage between the discharge chamber D and the introduction chamber I by means of one gasket retainer 790. A shape and a size of the periphery of the gasket retainer 790 is preferably the same as a shape and a size of the outer periphery of the partition wall 138.

Particularly, the bead portion 792 is formed along a periphery on the gasket retainer upper surface 790a to surround the injection valve 720, while protruding in a direction of the partition wall 138. Accordingly, when the gasket retainer 790 is compressed between the partition wall 138 and the valve plate 730, the bead portion 792 may seal a periphery of the injection valve 720 against the partition wall 138. Moreover, when the gasket retainer 790 and the injection valve 720 are assembled, the bead portion 792 is pressed in a direction toward the valve plate 730 by the partition wall 138 at the periphery of the gasket retainer. At the same time, an inner portion of the gasket retainer 790 facing the injection valve 720 receives a force, and thus, is bent in an opposite direction to a direction in which the bead portion 792 is pressed, that is, a direction toward the injection valve 720. That is illustrated in dotted arrows in FIG. 8. Accordingly, the inner portion of the gasket retainer 790 makes the injection valve come into close contact with the cover plate to become capable of sealing, and as a result, the leakage of the refrigerant may be prevented. To this end, a height of protrusion of the bead portion 792 may be equal to or greater than a thickness of the injection valve 720.

Further, the gasket retainer 790 further includes a third fastening hole 796 formed to penetrate the gasket retainer 790 from the gasket retainer upper surface 790a to the gasket retainer lower surface 790b on an outer periphery of the gasket retainer 790 so as to be communicated with the second fastening hole 714 and penetrated by the fastening bolt 770. In addition, the gasket retainer 790 further includes a third positioning hole 798 formed to penetrate the gasket retainer 790 from the gasket retainer upper surface 790a to the gasket retainer lower surface 790b so as to be communicated with the second positioning hole 726a and allow the positioning pin 780 to be inserted thereinto. In the present embodiment, the third positioning hole 798 is formed between the first and second retainer portions 794a and 794b, but is not limited thereto.

As such, the third fastening hole 796 is formed on a radially outside of the bead portion 792, and the third positioning hole 798 is formed on a radially inside of the bead portion 792, therefore, it is possible to precisely align the gasket retainer 790 with the other components of the injection valve assembly to assemble on an inside of the bead portion, and to obtain sealing as the bead portion 792 is compressed by the fastening force of the fastening bolt 770 on an outside of the bead portion.

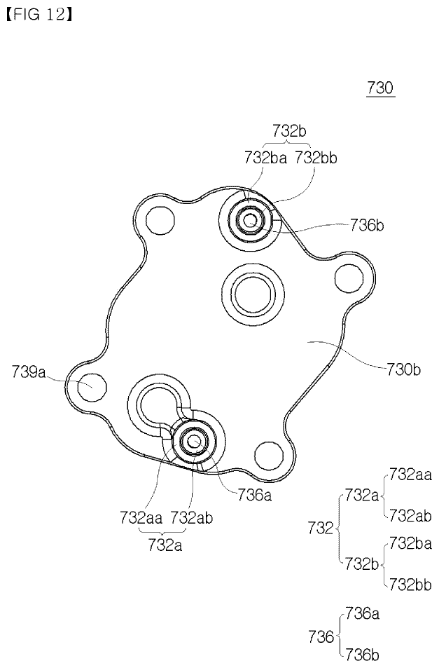

Next, as shown in FIGS. 7 and 12, the valve plate 730 includes a valve plate upper surface 730a opposite to the gasket retainer 790, and a valve plate lower surface 730b opposite to the fixed scroll 500 while forming a rear surface of the valve plate upper surface 730a. In addition, the valve plate 730 further includes a protrusion 732 protruding toward the inlet 514 from the valve plate lower surface 730b. That is, the valve plate 730 includes a first protrusion 732a protruding toward the first inlet 514a from one side of the valve plate lower surface 730b, and a second protrusion 732b protruding toward the second inlet 514b from the other side of the valve plate lower surface 730b.

Here, the first protrusion 732a may include a first great-diameter portion 732aa protruding from one side of the valve plate lower surface 730b toward the first injection hole 514a, and a first small-diameter portion 732ab more protruding from the first great-diameter portion 732aa toward the first injection hole 514a. An outer diameter of the first great-diameter portion 732aa may be greater than an outer diameter of the first small-diameter portion. Similarly, the second protrusion 732b includes a second great-diameter portion 732ba protruding toward the second inlet 514b from the other side of the valve plate lower surface 730b, and a second small-diameter portion 732bb more protruding toward the second inlet 514b from the second great-diameter portion. An outer diameter of the second great-diameter portion 732ba may be greater than an outer diameter of the second small-diameter portion 732bb.

In addition, the valve plate 730 may further include a first inclined space 734a receiving a refrigerant introduced through the first inlet 712a, a second inclined space 734b receiving a refrigerant introduced through the second inlet 712b, a first outlet 736a formed on the first protrusion 732a and guiding the refrigerant of the first inclined space 734a to the first inlet 514a, and a second outlet 736b formed on the second protrusion 732b and guiding the refrigerant of the second inclined space 734b to the second inlet 514b.

The first inclined space 734a and the second inclined space 734b are formed to be engraved from the valve plate upper surface 730a. In addition, the first inclined space 734a and the second inclined space 734b are separated from each other, and are preferably formed to be inclined in directions mutually opposite to each other so as to correspond to the first retainer portion 794a and the second retainer portion 794b, so that each of the first retainer portion 794a and the second retainer portion 794b can be seated on each of the first retainer portion 794a and the second retainer portion 794b, respectively.

The first outlet 736a may be engraved from an end surface of the first protrusion 732a, more precisely, an end surface of the first small-diameter portion 732ab, extend to the first great-diameter portion 732aa, and be communicated with the first inclined space 734a. The second outlet 736b may be engraved from an end surface of the second protrusion 732b, more precisely, an end surface of the second small-diameter portion 732bb, extend to the second great-diameter portion 732ba, and be communicated with the second inclined space 734b. However, the present disclosure is not limited thereto, and the first inclined space 734a and the first outlet 736a may be connected through an additional connecting flow path, and the second inclined space 734b and the second outlet 736b may be connected through an additional connecting flow path as well.

As shown in FIG. 3, the valve plate lower surface 730b may be formed to be spaced apart from the fixed base plate 510, so that the discharge valve 600 may be interposed between the fixed base plate 510 and the valve plate lower surface 730b, and the refrigerant discharged from the discharge hole 512 may flow into the discharge chamber D.

In addition, the valve plate 730 may further include a first fastening hole 739a formed to penetrate the valve plate 730 from the valve plate upper surface 730a to the valve plate lower surface 730b on an outer periphery of the valve plate 730, to be communicated with the third fastening hole 796, and to be penetrated by the fastening bolt 770. In addition, the valve plate 730 may further include a second positioning groove 739b engraved from the valve plate upper surface 730a, to be communicated with the third positioning hole 798, and so that the positioning pin 780 is inserted thereinto.

Therefore, one end of the positioning pin 780 passes through the first positioning hole 716 and is inserted into the first positioning groove 138b, and the other end of the positioning pin 780 passes through the second positioning hole 726a and the third positioning hole 798 and is inserted into the second positioning groove 739b, so that the cover plate 710, the injection valve 720, the gasket retainer 790, and the valve plate 730 can be aligned. In addition, the fastening bolt 770 passes through the first fastening hole 739a and the third fastening hole 796 and is fastened to the fastening groove 138a, so that the injection valve assembly 700 can be fastened to the rear housing 130.

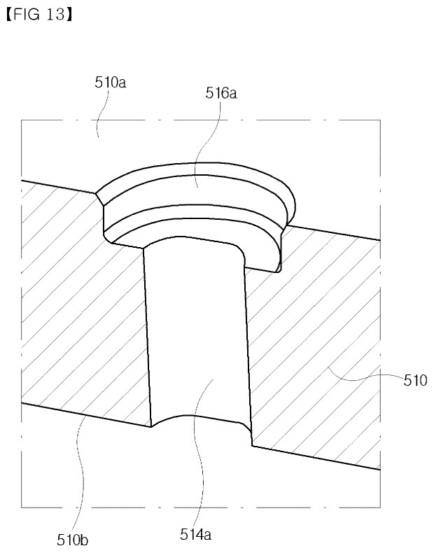

Meanwhile, as shown in FIGS. 3, 6, and 13, the fixed base plate 510 may further include a small-diameter portion insertion groove 516 to prevent refrigerant leakage when the refrigerant flows from the injection valve assembly 700 to the first injection hole 514a and the second injection hole 514b. That is, the fixed base plate 510 may further include a first small-diameter portion insertion groove 516a into which the first small-diameter portion 732ab is inserted, and a second small-diameter portion insertion groove 516b into which the second small-diameter portion 732bb is inserted.

Specifically, the fixed base plate 510 may include a fixed base plate upper surface 510a opposite to the injection valve assembly 700 and a fixed base plate lower surface 510b forming the rear surface of the fixed base plate upper surface 510a and opposite to the orbiting scroll 400.

In addition, the first small-diameter portion insertion groove 516a is engraved from the fixed base plate upper surface 510a toward the fixed base plate lower surface 510b, the first small-diameter portion 732ab is inserted thereinto, and the first injection hole 514a is engraved from the fixed base plate lower surface 510b toward the fixed base plate upper surface 510a and communicates with the first small-diameter portion insertion groove 516a. In addition, the second small-diameter portion insertion groove 516b is engraved from the fixed base plate upper surface 510a toward the fixed base plate lower surface 510b, the second small-diameter portion 732bb is inserted thereinto, and the second injection hole 514b is engraved from the fixed base plate lower surface 510b toward the fixed base plate upper surface 510a and communicates with the second small-diameter portion insertion groove 516b.

Here, an inner diameter of the first small-diameter portion 732ab (inner diameter of the first outlet 736a) may be formed to be greater than or equal to an inner diameter of the first injection hole 514a, and an inner diameter of the first small-diameter portion insertion groove 516a may be formed at the same level as an outer diameter of the first small-diameter portion 732ab, so that the first small-diameter portion 732ab may be inserted into the first small-diameter portion insertion groove 516a, and pressure loss and flow rate loss do not occur while the refrigerant flows from the injection valve assembly 700 to the first injection hole 514a.

In addition, an inner diameter of the second small-diameter portion 732bb (inner diameter of the second outlet 736b) may be formed to be greater than or equal to the inner diameter of the second injection hole 514b, and an inner diameter of the second small-diameter portion insertion groove 516b may be formed at the same level as an outer diameter of the second small-diameter portion 732bb, so that the second small-diameter portion 732bb can be inserted into the second small-diameter portion insertion groove 516b, and pressure loss and flow rate loss do not occur while the refrigerant flows from the injection valve assembly 700 to the second injection hole 514b.

Meanwhile, in the first great-diameter portion 732aa, the outer diameter of the first great-diameter portion 732aa may be greater than the inner diameter of the first small-diameter portion insertion groove 516a, so that the first great-diameter portion 732aa may not be inserted into the first small-diameter portion insertion groove 516a. Because of this, when the injection valve assembly 700 is fastened to the fixed scroll 500, a sealing member 760 may be interposed between an end surface of the first great-diameter portion 732aa and the fixed base plate upper surface 510a. A thickness of the sealing member 760 before deformation may be formed greater than or equal to a gap between the end surface of the first great-diameter portion 732aa and the fixed base plate upper surface 510a, so that the sealing member 760 can be compressed between the end surface of the first great-diameter portion 732aa and the fixed base plate upper surface 510a.

In addition, a protrusion length of the first small-diameter portion 732ab, that is, an axial distance between the end surface of the first great-diameter portion 732aa and the end surface of the first small-diameter portion 732ab may be formed greater than a thickness before deformation of the sealing member 760, and may be formed to be less than or equal to sum of a thickness before deformation of the sealing member 760 and an axial depth of the first small-diameter portion insertion groove 516a. Accordingly, the end surface of the first small-diameter portion 732ab may not be in contact with a base surface of the first small-diameter portion insertion groove 516a and the sealing member 760 may be compressed between the end surface of the first great-diameter portion 732aa and the fixed base plate upper surface 510a.

Similarly, in the second great-diameter portion 732ba, the outer diameter of the second great-diameter portion 732ba may be greater than the inner diameter of the second small-diameter portion insertion groove 516b, so that the second great-diameter portion 732ba may not be inserted into the second small-diameter portion insertion groove 516b. Accordingly, when the injection valve assembly 700 is fastened to the fixed scroll 500, the sealing member 760 may be interposed between an end surface of the second great-diameter portion 732ba and the fixed base plate upper surface 510a to be compressed therebetween.

In addition, in the second small-diameter portion 732bb, a protrusion length of the second small-diameter portion 732bb, which is an axial distance between the end surface of the second great-diameter portion 732ba and the end surface of the second small-diameter portion 732bb, may be formed greater than a thickness before deformation of the sealing member 760, and may be formed to be less than or equal to sum of a thickness before deformation of the sealing member 760 and an axial depth of the second small-diameter portion insertion groove 516b. Therefore, the end surface of the second small-diameter portion 732bb may not be in contact with a base surface of the second small-diameter portion insertion groove 516b, and the sealing member 760 may be compressed between the end surface of the second great-diameter portion 732ba and the fixed base plate upper surface 510a.

Meanwhile, as shown in FIG. 6, a third groove 518 and a fourth groove 519 may be formed in the fixed base plate 510.

The third groove 518 is for reducing a contact area between the main opening/closing portion 610 of the discharge valve 600 and the fixed base plate 510 to reduce collision noise between the main opening/closing portion 610 of the discharge valve 600 and the fixed base plate 510, and is for preventing foreign substances from being caught between the main opening/closing portion 610 of the discharge valve 600 and the fixed base plate 510 by collecting and discharging foreign substances, and may be formed in an annular shape surrounding the main discharge hole 512a while being engraved from the fixed base plate upper surface 510a. An inner periphery of the third groove 518 may be formed to overlap an outer periphery of the main opening/closing portion 610 in an axial direction, and an outer periphery of the third groove 518 may be formed to not overlap the main opening/closing portion 610 in the axial direction. That is, an inner diameter of the third groove 518 may be formed to be smaller than an outer diameter of the main opening/closing portion 610, and an outer diameter of the third groove 518 may be formed to be greater than an outer diameter of the main opening/closing portion 610. This aims to allow foreign substances collected in the third groove 518 to be discharged to the discharge chamber D.

The fourth groove 519 is for collecting and discharging foreign substances to prevent foreign substances from being caught between the main supporting portion 620, the first sub supporting portion 640, and the second sub supporting portion 660 (hereinafter, the supporting portion) of the discharge valve 600 and the fixed base plate 510, and may be formed to be engraved from the fixed base plate upper surface 510a at a position opposite to the supporting portion of the discharge valve 600. In addition, the fourth groove 519 is formed in a long hole shape, a central portion of the fourth groove 519 is formed to overlap the supporting portion of the discharge valve 600 in an axial direction, and both ends of the fourth groove 519 may be formed to be non-overlapping the supporting portion of the discharge valve 600 in the axial direction. That is, a long axis direction of the fourth groove 519 and a width direction of the supporting portion of the discharge valve 600 may be parallel to each other, and a long axis length of the fourth groove 519 may be greater than a width of the supporting portion of the discharge valve 600. This aims to allow foreign substances collected in the fourth groove 519 to be discharged to the discharge chamber D.

Hereinafter, the operation and the effects of the scroll compressor according to the present embodiment will be described.

That is, when power is applied to the motor 200, the rotary shaft 300 may rotate together with the rotor 220, and the orbiting scroll 400 may be orbital moved by receiving the rotational force from the rotary shaft 300 through the eccentric bush 310. Accordingly, a volume of the compression chamber C may be reduced while continuously moving toward a center side.

Therefore, the refrigerant sucked into the compression chamber C may be compressed while moving toward the center along a movement path of the compression chamber C and discharged to the discharge chamber D through the discharge hole 512. The refrigerant of the discharge pressure discharged to the discharge chamber D may be discharged to the outside of the compressor through the discharge port 131. Here, the refrigerant of the suction pressure may be introduced into the compression chamber C by passing through the suction port, the motor accommodating space, the suction flow path, and the scroll accommodating space.

In addition, the scroll compressor according to this embodiment includes the injection flow path (introduction port 133, introduction chamber I, injection valve assembly 700, injection hole 514) for guiding the middle-pressure refrigerant to the compression chamber C, and compresses and discharges the refrigerant of suction pressure as well as the middle-pressure refrigerant. That is, the suction pressure refrigerant introduced into the housing 100 after passing through the evaporator is introduced into the compression chamber C through the front housing 120, and at least a part of the refrigerant discharged to the outside of the housing 100 may be introduced from the outside, in a state of the middle-pressure before passing through the evaporator, into the compression chamber C through the injection flow path. Therefore, the refrigerant discharge amount may be increased than when only the refrigerant of suction pressure is sucked, compressed, and discharged. Thereby, the performance and efficiency of the compressor may be improved.

In addition, since the rear housing 130 includes not only the discharge chamber D and the discharge port 131, but also the introduction port 133 and the introduction chamber I, that is, the rear housing having the discharge chamber D, the discharge port 131, the introduction port 133, and the introduction chamber I is formed integrally, the likelihood of a leakage is declined and the size, cost and weight may be reduced.

The present invention is not limited to the above-described specific embodiments and descriptions, and various modifications may be made by those skilled in the art without departing from the gist of the present invention claimed in the claims. Such variations are within the protection scope of the present invention.

The present disclosure relates to a scroll compressor, more particularly, a scroll compressor capable of improving the performance and efficiency of the compressor by introducing not only a suction-pressure refrigerant, but also a middle-pressure refrigerant into a compression chamber of the scroll compressor so as to increase a refrigerant discharge amount discharged from the compression chamber.

1-14. (canceled)

15. A scroll compressor, comprising:
a housing;
a motor provided inside the housing;
a rotary shaft configured to be rotated by the motor;
an orbiting scroll configured to orbit in conjunction with the rotary shaft; and
a fixed scroll configured to define a compression chamber together with the orbiting scroll, wherein the housing further comprises a rear housing which defines a discharge chamber configured to accommodate a refrigerant discharged from the compression chamber, wherein an injection valve assembly configured to define an introduction chamber into which the refrigerant is introduced from an outside of the housing in the rear housing and guide the refrigerant of the introduction chamber to the compression chamber is provided between the fixed scroll and a partition wall of the rear housing, and wherein in the partition wall, a stepped portion on which a part of the injection valve assembly is seated is provided.

16. The scroll compressor of claim 15, wherein the partition wall protrudes from a rear base plate of the rear housing so as to form a space of the introduction chamber therein, and the stepped portion is formed along an inner periphery of the partition wall.

17. The scroll compressor of claim 16, wherein the injection valve assembly further comprises a gasket retainer configured to prevent a leak between the discharge chamber and the introduction chamber, and wherein the gasket retainer is coupled to the partition wall so as to surround the stepped portion.

18. The scroll compressor of claim 17, wherein a shape and a size of a periphery of the gasket retainer are identical to a shape and a size of an outer periphery of the partition wall.

19. The scroll compressor of claim 17, wherein the injection valve assembly further comprises:
a cover plate seated on the stepped portion and having an inlet into which the refrigerant from the introduction chamber is introduced;
an injection valve interposed between the cover plate and the gasket retainer and configured to open or close the inlet; and
a valve plate coupled to the gasket retainer and having an outlet through which the refrigerant introduced from the inlet is discharged.

20. The scroll compressor of claim 19, wherein a shape and a size of an outer periphery of the stepped portion are identical to a shape and a size of a periphery of the cover plate.

21. The scroll compressor of claim 19, wherein a height (h) of the stepped portion is identical to a thickness (t) of the cover plate.

22. The scroll compressor of claim 19, wherein the gasket retainer is compressed between the partition wall and the valve plate, and wherein the injection valve is compressed between the gasket retainer and the cover plate.

23. The scroll compressor of claim 22, wherein the gasket retainer further comprises a bead portion protruding from an upper surface of the gasket retainer opposite to the partition wall, and wherein the bead portion surrounds the injection valve.

24. The scroll compressor of claim 23, wherein when the gasket retainer is assembled between the partition wall and the valve plate, the bead portion is pushed in a direction toward the valve plate by the partition wall, and an internal portion of the gasket retainer facing the injection valve is bent in a direction toward the injection valve.

25. The scroll compressor of claim 23, wherein the gasket retainer further comprises one or more retainer portions formed to be inclined in a direction in which the injection valve is opened.

26. The scroll compressor of claim 19, wherein a fastening bolt penetrates the valve plate and the gasket retainer to be fastened to the rear housing.

27. The scroll compressor of claim 19, wherein a positioning pin has one end inserted into the valve plate to penetrate the gasket retainer, the injection valve, and the cover plate, and another end inserted into the rear housing.

28. The scroll compressor of claim 15, wherein the housing further comprises a center housing allowing the rotary shaft to penetrate, and a front housing forming a motor accommodating space in which the motor is accommodated together with the center housing, and wherein a sucked portion of the refrigerant is introduced through the front housing into the compression chamber, and at least a part of the refrigerant discharged outside the housing is introduced, in a state of middle-pressure, from the outside of the housing into the introduction chamber, and introduced into the compression chamber through the injection valve assembly.
